(19) United States
(12) Patent Application Publication
(10) Pub. No.: US 2017/0241415 A1
(43) Pub. Date: Aug. 24, 2017

(54) SANITARY CHECK VALVE

(71) Applicant: Alberto Bazan, Duluth, GA (US)

(72) Inventor: Alberto Bazan, Duluth, GA (US)

(73) Assignee: Muzan, Inc., Norcross, GA (US)

(21) Appl. No.: 15/048,286

(22) Filed: Feb. 19, 2016

(51) Int. Cl. F04B 53/10; F04B 43/02; F16K 15/03

(52) U.S. Cl. CPC F04B 53/1097; F16K 15/03; F04B 43/028; F04B 53/102; F04B 53/1087

(57) ABSTRACT

A sanitary check valve having an open hook hinge coupling the valve disc to the valve body. The open hook hinge comprises a pair of open hook receivers coupled to the valve body, each open hook receiver adapted to receive a respective free end of a pin which is coupled to the valve disc. The open hook hinge prevents separation of valve disc from valve body during operations while permitting thorough cleaning and sanitation of sanitary check valve.

### FIELD OF THE INVENTION

The present disclosure generally relates to systems for moving fluid products. More specifically, the present disclosure is directed to a check valve for use in a diaphragm pump and check valve assembly which is used to transport fluid products.

### BACKGROUND

Diaphragm pumps have been used for more than 150 years to move fluids. Diaphragm pumps are today used to provide motive force to consumer products in a fluid state such as some foods, beverages, pharmaceuticals, cosmetics, and the like. Diaphragm pumps provide several advantages over rotary or centrifugal pumps, namely strong suction, the ability to move highly-viscous fluids or fluids with suspended particulates, and the ability to move fragile or delicate products.

Diaphragm pumps are typically used in a system of valves, pipes and/or hoses, and containers when moving consumer products. For example, U.S. patent application Ser. No. 14/450,009, filed Aug. 1, 2014 by the same inventor and commonly owned with the present application, discloses a fully-draining system comprising a diaphragm pump and ball valves to be used for moving consumer products.

When moving consumer products with large particulates or fragile particulates, ball valves are replaced with check valves (or “flapper valves”) to give a diaphragm pump the ability to pass large solids. For example, systems for moving chicken feet, chicken heads, chicken gizzards, and the like require check valves instead of ball valves. Similarly, fluids having fragile particulates such as cottage cheese require check valves instead of ball valves which can damage the particulate matter. Check valves are used in place of ball valves as they provide a larger diameter flow passage in the valve, thus allowing larger particulates and solids to flow through the valve. Check valves have been used in conjunction with diaphragm pumps for moving viscous fluids for at least the past several decades.

Since it is generally desirable to sequentially use a single diaphragm pump for more than one fluid product, the pump and associated systems—including valves, pipes, hoses, and containers—must be cleaned prior to introducing each new product into the system to prevent product mixing and cross-contamination. For example, if a diaphragm pump is used to move a shampoo product, it must be cleaned after completion of the shampoo movement and before subsequent use to move a conditioner product so that residual shampoo in the pump does not mix with the conditioner.

Particularly when handling food and beverage products, the cleaning of the diaphragm pump and associated systems is crucially important. Proper sanitation of pumps, valves, pipes, hoses, and containers prevents the spread of harmful bacteria and cross-contamination of subsequent products with prior products. However, cleaning is often time- and labor-intensive and in some systems is difficult to accomplish properly.

Many valves in the prior art have regions that constitute dead space; that is, many valves have areas of no flow or low flow where fluid will enter during pumping operations but, due to the low or no flow, will not be replaced by fresh fluid. Dead space is problematic during cleaning operations as fluid product becomes trapped and is not removed by standard system flushing with cleansers or sanitizers. Fluid product in a dead space leads to cross-contamination or bacterial growth.

Dead space is further problematic because they are regions where moisture is likely to be retained in a system. Certain fluid products require a high level of dryness (or a low level of system humidity) prior to introducing a product. Dead space is thus problematic as a collecting area for moisture and liquids, such that fluid products requiring high dryness prior to introduction into the system can come into contact with liquid in these areas.

Where pumping systems are used sequentially with multiple products, dead space also is problematic as residuals of a first product may linger in dead space and then cross-contaminate a second product. This is particularly problematic during the pumping of chemical fluids, hazardous fluids, and similar fluid products. Although the pumping of hazardous fluids such as highly-corrosive fluids, toxic fluids, radioactive fluids, and similar fluids presents its own challenges, one issue is the retention of such fluids in system dead spaces.

Prior art efforts to remove dead space from pumping assemblies include the reduction, restriction, or elimination of moving parts such as check valve discs and pump rotors. However, further reduction of moving parts in a diaphragm pump assembly is not practicable, as check valves and their discs are necessary to the operation of the diaphragm pump. Ball valves, which typically have less dead space than check valves, may be considered a partial solution to the dead space problem. However, as discussed above, in systems for transport of fluids with large particulates or solids, or fluids having fragile particulates, ball valves are ineffective to support the passage of such fluids.

Additional efforts to remove dead space have included the use of seals, gaskets, or similar materials to seal off dead space. The use of dead space seals is problematic due to the difficulty of using seals in close proximity to moving parts, the maintenance and replacement costs associated with such materials, and the difficulty in sanitizing some sealing materials.

There is thus a need in the art for improvements to consumer product processing equipment that allow for faster, less expensive, and more effective cleaning and sanitation of such equipment.

### SUMMARY

It is thus an object of the present disclosure to present an apparatus, systems, and methods to overcome the deficiencies in the prior art discussed above. Specifically, the present disclosure provides a sanitary check valve which removes dead space leading to faster, less expensive and time consuming, and more effective cleaning of the check valve.

In one aspect of the present disclosure, a sanitary check valve comprises a valve body having a flow aperture and a seating surface disposed circumferentially about the flow aperture; a valve disc adapted to seat against the seating surface to prevent fluid flow in a first direction and to separate from the seating surface to permit fluid flow in a second direction; at least one open hook receiver coupled to the valve body; a hinge pin coupled to the valve disc, the hinge pin removeably attached to the at least one open hook receiver; wherein the hinge pin rotates in the at least one open hook receiver to separate the valve disc from the seating surface.

In another aspect of the present disclosure, a system for providing motive force to a viscous fluid comprises a diaphragm pump adapted to take suction from a suction manifold and discharge to a discharge manifold; a first sanitary check valve coupled between said diaphragm pump and said suction manifold; a second sanitary check valve coupled between said diaphragm pump and said discharge manifold; wherein said first and second sanitary check valves are adapted to permit fluid flow only in a direction from the suction manifold toward the discharge manifold; and wherein said first and second sanitary check valves each comprise: a valve body having a seating surface; a valve disc; and a hinge for coupling said valve disc with said valve body wherein said hinge comprises a pair of open hook receivers coupled to said valve body and adapted to receive a respective free end of a pin coupled to said valve disc.

In a further aspect of the present disclosure, a method of cleaning a check valve having a valve body having a flow aperture and a pair of open hook receivers; a valve disc biased to be disposed across the flow aperture when fluid is flowing in a first direction or when there is no fluid flowing, and to lift away from the flow aperture when fluid is flowing in a second direction; wherein the valve disc is coupled to the valve body via a hinge pin, the free ends of which are received by the pair of open hook receivers; the method comprising disassembling the check valve by moving the valve disc and hinge pin in a direction transverse to the direction of fluid flow to disengage the hinge pin from the open hook receivers; and applying a cleaning solution to the valve body.

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1A is a perspective view of a typical check valve used in the prior art.

FIG. 1B is a profile view of a typical check valve used in the prior art.

FIG. 1C is a detailed cutaway profile view of a typical check valve used in the prior art.

FIG. 1D is a partial schematic profile view of a typical check valve used in the prior art.

FIG. 2A is a profile view of a modified check valve used in the prior art that reduces or eliminates some of the drawbacks associated with the typical check valve illustrated in FIGS. 1A-1D.

FIG. 2B is a profile view of a modified check valve used in the prior art that reduces or eliminates some of the drawbacks associated with the typical check valve illustrated in FIGS. 1A-1D.

FIG. 2C is a perspective view of a ferrule and a modified check valve used in the prior art that reduces or eliminates some of the drawbacks associated with the typical check valve illustrated in FIGS. 1A-1D.

FIG. 3A is a profile view of a sanitary check valve in accordance with some embodiments of the present disclosure.

FIG. 3B is a perspective view of a sanitary check valve in accordance with some embodiments of the present disclosure.

FIG. 3C is a perspective view of a partially-disassembled sanitary check valve in accordance with some embodiments of the present disclosure.

FIG. 4A is a side profile view of an open hook receiver of a sanitary check valve in accordance with some embodiments of the present disclosure.

FIG. 4B is a side profile view of an open hook receiver of a sanitary check valve in accordance with some embodiments of the present disclosure.

FIG. 4C is a side profile view of an open hook receiver of a sanitary check valve in accordance with some embodiments of the present disclosure.

FIG. 5 is a schematic diagram of a diaphragm pump and sanitary check valve assembly in accordance with some embodiments of the present disclosure.

FIG. 6 is a flow diagram of a method in accordance with some embodiments of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

The present disclosure is directed to a sanitary check valve, a sanitary check valve assembly, and methods of using the same. The check valve disclosed herein uses an open hook hinge design to eliminate dead space and prevent consumer products from becoming trapped and thus improving the ability to clean and sanitize the check valve. This design ensures that fluids cannot become trapped in the check valve or check valve assembly which could cause undesirable fluid product mixing or bacteria growth.

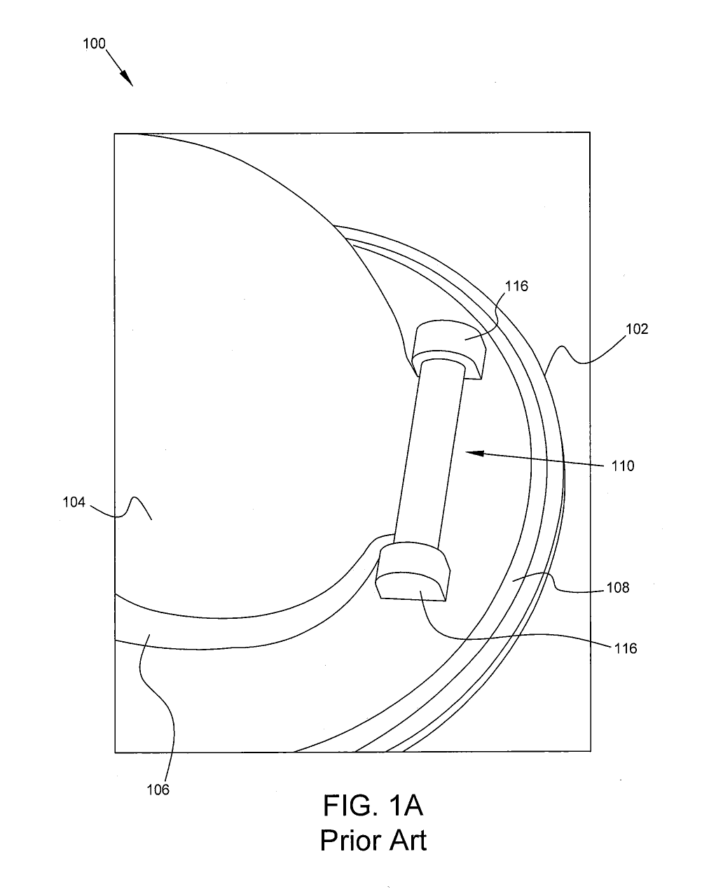

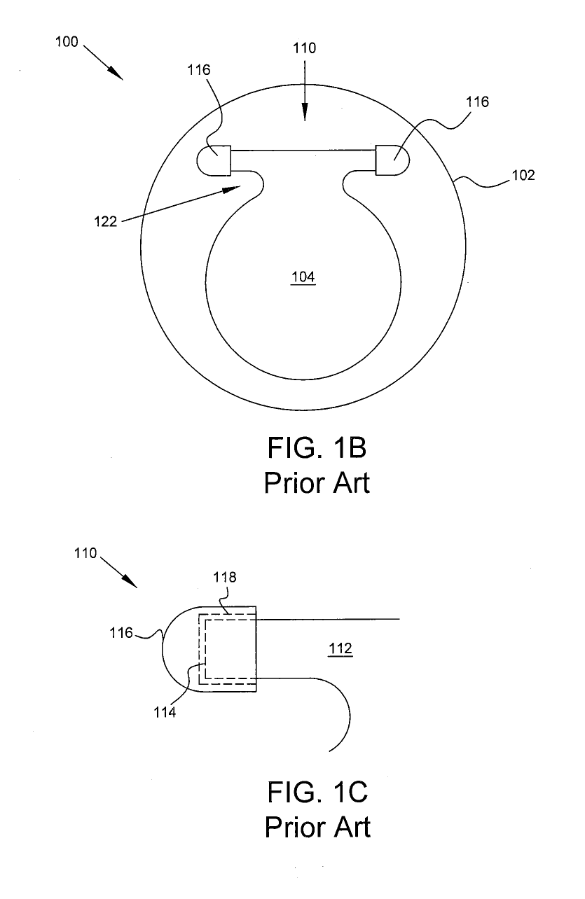

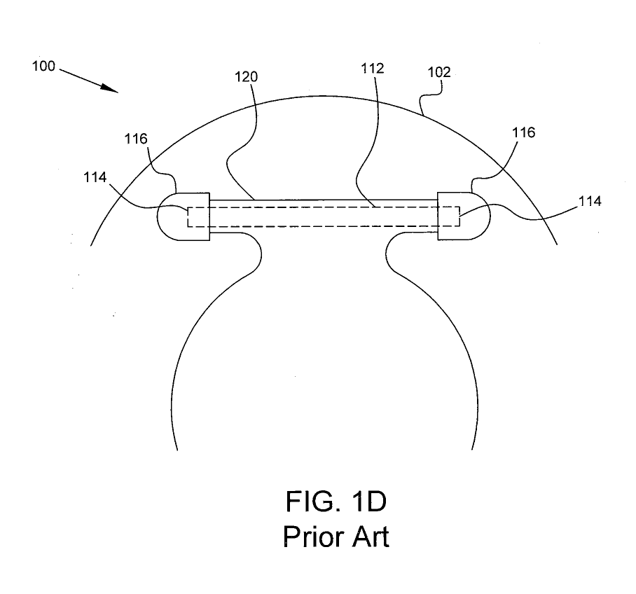

FIGS. 1A, 1B, 1C and 1D provide views of a typical check valve 100 used in the prior art. Check valve 100 comprises a body 102 and disc 104. Body 102 defines a flow aperture 105, a seating surface 106 disposed circumferentially about the flow aperture 105, and a groove 108 adapted to receive a gasket ring when mating body 102 to a pipe, diaphragm pump, ferrule, or similar component.

Disc 104 is coupled to body 102 by hinge 110. In some embodiments hinge 110 is a dual-sided barrel hinge. Hinge 110 typically comprises a pin 112 having opposing free ends 114 and a pair of closed pin receivers 116 which are attached to body 102 and each have a cavity 118 adapted to receive an opposing free end 114 of pin 112. In common designs such as that shown in FIGS. 1B and 1C, pin 112 is attached to disc 104. The attachment is usually made via a welded bead or neck 122 which connects pin 112 to disc 104. As illustrated in FIG. 1D, pin 112 is sometimes not directly attached to disc 104 but rather is disposed within a knuckle 120 which is attached to disc 104.

To couple disc 104 to body 102, each opposing free end 114 of pin 112 is disposed within a cavity 118 of a respective closed pin receiver 116.

Thus disc 104 is permitted to articulate between a closed position where disc 104 is pressed against seating surface 106 and an open position where disc is not pressed against seating surface 106. Since hinge 110 and seating surface 106 only permit disc 104 to open in one direction, check valve 100 allows only a single direction of fluid flow through the valve.

Check valve 100 such as described with respect to FIGS. 1A-1D has serious drawbacks when used in systems for moving fluid consumer products, particularly fluid consumer products requiring a high degree of sanitation such as food or beverage products. First, because closed pin receiver 116 is typically welded to body 102 and pin 112 or knuckle 120 are typically welded to disc 104, there is no way to disassemble hinge 110, thereby creating regions which constitute dead space. This means that it is extremely difficult to fully clean disc 104 and hinge 110. Further, fluid consumer products can enter and become trapped in cavity 118. Fluid residues which remain in cavity 118 after cleaning can lead to bacterial growth and food contamination. Without disassembly, it is also extremely difficult and sometimes impossible to visually inspect the cleanliness of check valve 100. As discussed above, the dead space of hinge 110 will also cause problems when check valve 100 is used in a pumping system for moving fluid product with specific dryness requirements, hazardous materials, and cleaning fluids. Each of these can become trapped or otherwise be contacted with moisture or previously-pumped product in a dead space. Thus in many respects check valve 100 is unsuitable for use in systems for moving fluid consumer products, particularly those fluid consumer products requiring a high degree of sanitation.

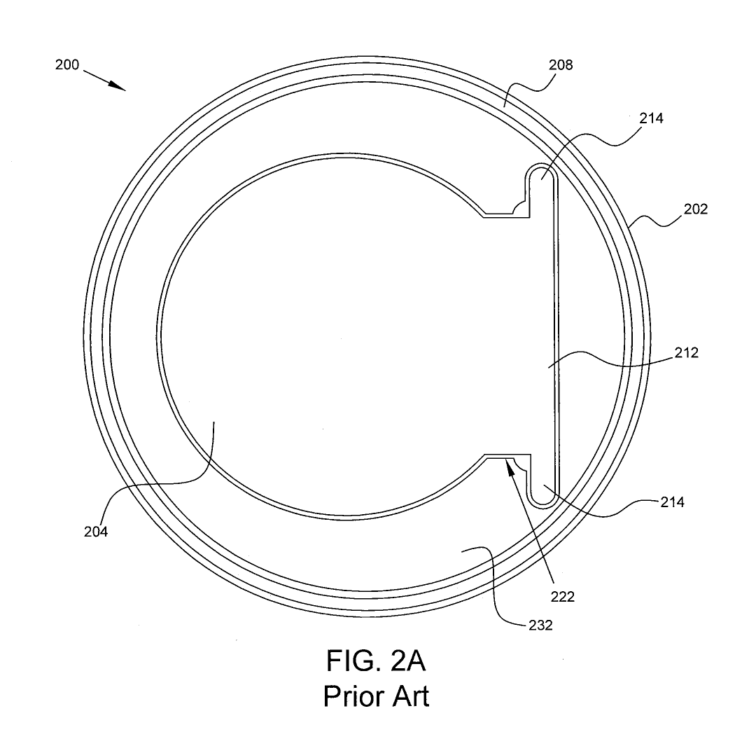

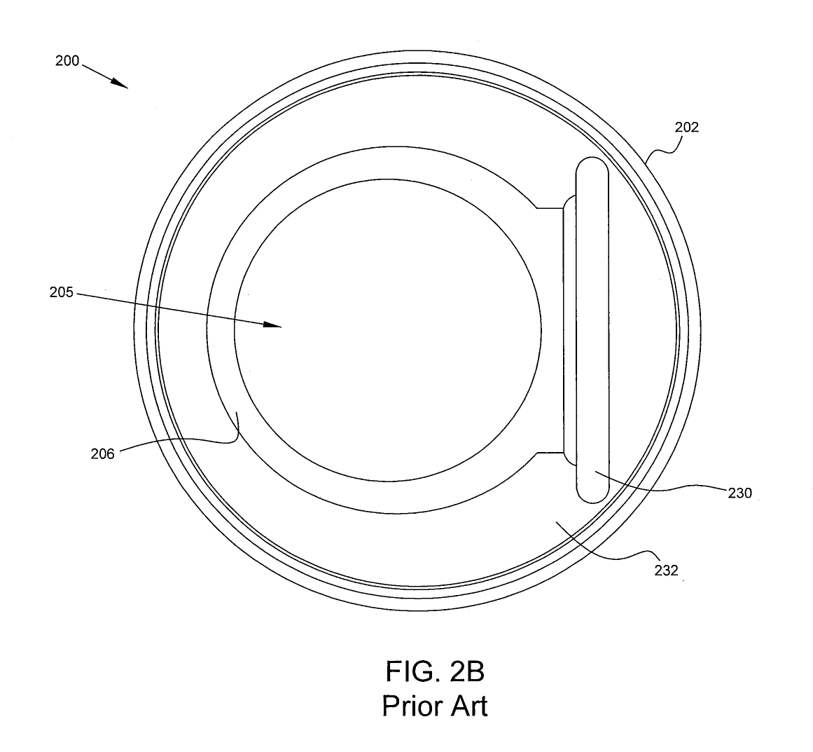

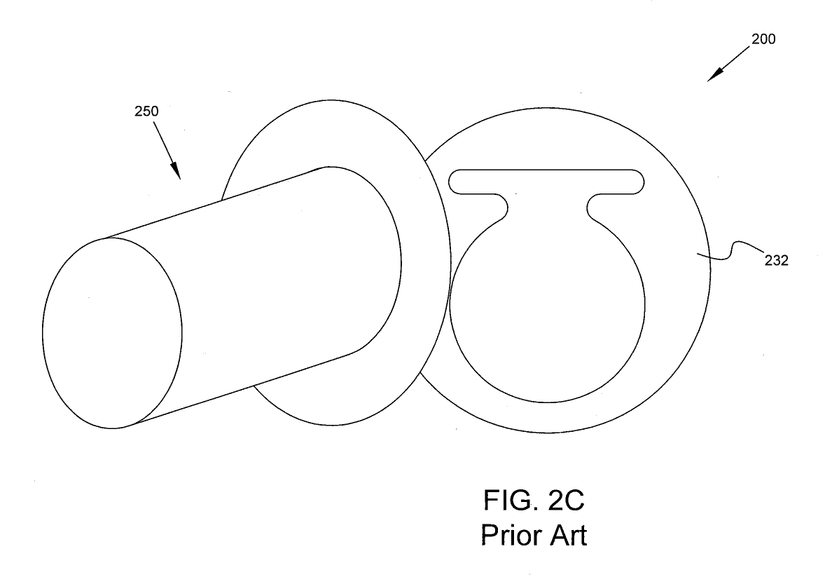

Modified check valve 200 sought to alleviate many of the drawbacks discussed above with respect to check valve 100. FIGS. 2A and 2B provide profile views of modified check valve 200 which comprises a body 202 and disc 204. Body has a flow aperture 205, seating surface 206 and gasket groove 208. A pin 212 is joined to disc 204 via neck portion 222. Pin 212 has opposing free ends 214. Pin 212 is disposed in a recessed portion 230 of body 202.

Disc 204 is not coupled to body 202; rather, when modified check valve 200 is placed in a fluid system a ferrule 250 is coupled to check valve 200 adjacent to first surface 232 as shown in FIG. 2C. Ferrule 250 is disposed adjacent to at least some portion of pin 212 and therefore maintains at least some portion of pin 212 disposed within recessed portion 230. The ferrule 250 is commonly disposed adjacent to at least opposing free ends 214 of pin 212, thus holding at least opposing free ends 214 in recessed portion 230. Thus disc 204 is permitted to open in a first direction of fluid flow, but will become pressed against sealing surface 206 in a second direction of fluid flow.

Modified check valve 200 thus presents a marked improvement over check valve 100, particularly when used in systems requiring sanitation. When the system is partially disassembled, including at least the disassembly of ferrule 250 from modified check valve 200, disc 204 is able to be completely removed from body 202. Disc 204, pin 112, and recessed portion 230 are able to be cleaned and visually inspected. No fluid products or fluid residues should remain in check valve 200, greatly improving sanitation of the system.

However, modified check valve 200 has an additional drawback. The retention of disc 204 depends on a proper fit and connection of modified check valve 200 to ferrule 250. When ferrule 250 is not properly sized or configured to hold at least some portion of pin 112 in recessed portion 230 of body 202, disc 104 can easily become separated from the remainder of modified check valve 200. Similarly, any loosening of the connection between ferrule 250 and modified check valve 200, misalignment of the ferrule 250 to check valve 200, missing gasket, loose clamps holding ferrule 250 to check valve 200, or similar problem risks separation of disc 104. Once free, disc 104 is likely to travel downstream in the fluid consumer product where it can cause serious damage to equipment—such as other check valves, diaphragm pumps, product processing components such as dicers, etc.—or where it will be mixed in with a fluid consumer product in its final disposition (i.e. in a holding tank, packaged with the product, etc.). Either of these outcomes is highly undesirable. The loss of disc 204 from check valve 200 is further undesirable because it can affect performance of the associated diaphragm pump and, in some instances, the associated diaphragm pump will no longer be able to impart motive force on the fluid consumer product.

It is therefore needed in the art to provide a highly sanitary check valve which is not susceptible to a separated disc casualty. Such a design would overcome the drawbacks associated with both the check valve 100 described above with reference to FIGS. 1A-1D and the modified check valve 200 described above with reference to FIGS. 2A-2C.

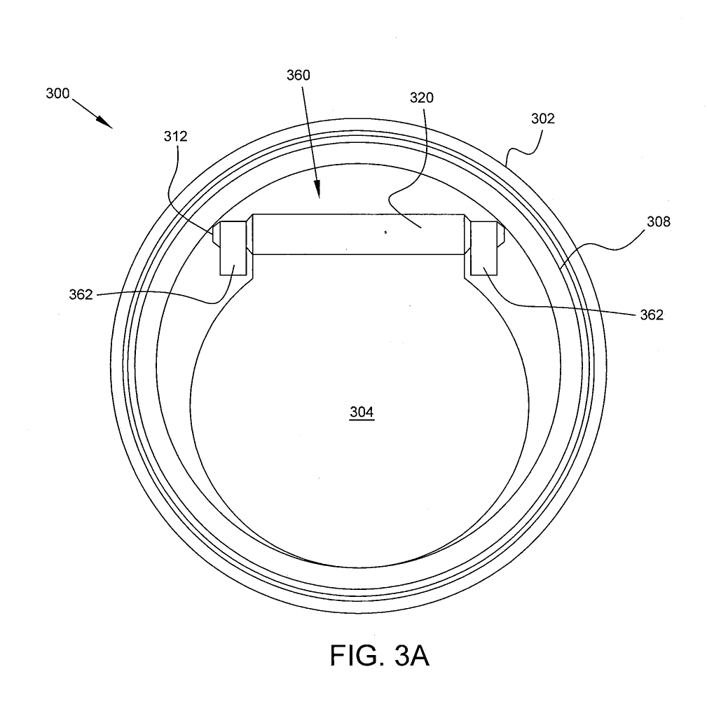

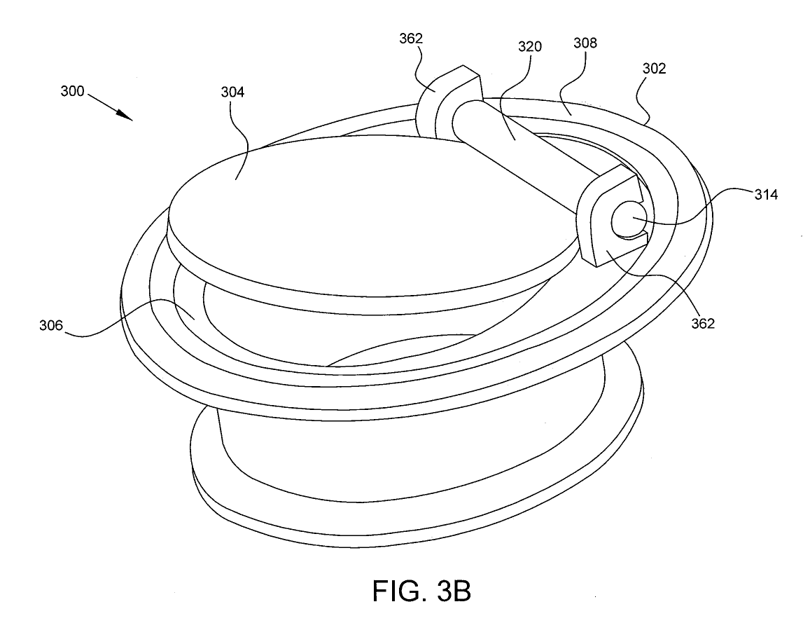

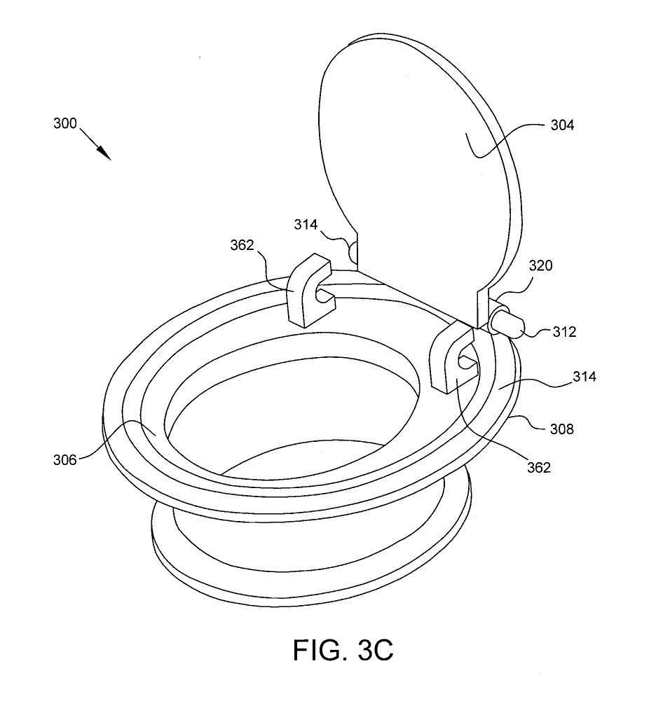

FIGS. 3A-3C provide depictions of a sanitary check valve 300 which overcomes the deficiencies of the prior art as described above. FIG. 3A is a profile view of a sanitary check valve 300 in accordance with some embodiments of the present disclosure. FIG. 3B is a perspective view of a sanitary check valve 300 in accordance with some embodiments of the present disclosure. FIG. 3C is a perspective view of a partially-disassembled sanitary check valve 300 in accordance with some embodiments of the present disclosure.

Sanitary check valve 300 comprises a body 302 and disc 304. Body 302 includes a seating surface 306 around flow aperture 305 and a groove 308 adapted to receive a gasket ring when mating body 302 to a pipe, diaphragm pump, ferrule, or similar component.

Disc 304 is coupled to body 302 by hinge 360. Valve disc 304 is biased to rest against the seating surface 306 when there is no flow through the flow aperture 305 or when fluid is attempting to flow through the flow aperture 305 in a first direction. Valve disc 304 is adapted to separate from seating surface 306 when fluid is attempting to flow through flow aperture 305 in a second direction which is opposite the first direction. Thus valve disc 304 controls fluid flow by no permitting fluid flow through flow aperture 305 in a first direction but allowing flow through the flow aperture 305 in a second direction. In some embodiments during low flow in the second direction the valve disc 304 will only partially separate from seating surface 305.

Hinge 360 comprises a pin 312 having a pair of opposing free ends 314 and a pair of open hook receivers 362 each adapted to receive one of the opposing free ends 314 of pin 312. Open hook receivers 362 comprise an axially-extending member 364 and a radially extending member 366 which together form a receiving surface 368 which at least partially defines a receiving region 370. Open hook receivers 362 are thus adapted to prevent valve disc 304 from entering the fluid flow in the second direction by retaining hinge pin 312.

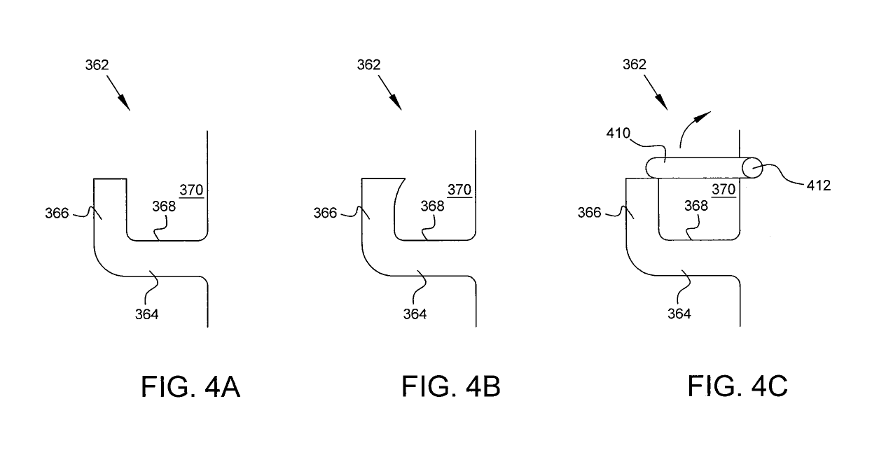

FIG. 4 provides detailed side profile views of various embodiments of open hook receivers 362 of a sanitary check valve 300 in accordance with some embodiments of the present disclosure. As shown in FIG. 4, in some embodiments an open hook receiver 362 has a radially extending member 366 with a uniform or substantially uniform axial thickness. In other embodiments an open hook receiver 362 has a radially extending member 366 with a axial thickness which increases as radially extending member 366 extends away from axially extending member 364 to provide assistance in retaining pin 312 in receiving region 370.

In still further embodiments an open hook receiver 362 is coupled with a retaining clip 410 to assist in retaining pin 312 in receiving region 370. In some embodiments retaining clip 410 articulates about a hinge 412 to permit insertion or removal of pin 312 from receiving region 370. In some embodiments hinge 412 is biased such that retaining clip 410 is biased to remain disposed across receiving region 370 (i.e. retaining clip 410 is biased to remain in contact with radially extending member 366).

Retaining clip 410 thus allows sanitary check valve 300 to be installed into a pumping system at any angle or disposition in which valve disc 304 would not otherwise hang vertically from hinge 360. For example, sanitary check valve 300 can be installed upside down (i.e. with hinge 360 at the bottom of the valve) and retaining clip 410 will not permit separation of valve disc 304 from valve body 302. In some embodiments, retaining clip 410 is replaced with a biasing mechanism, a spring, a detente, elastic material, or similar device for preventing separation of valve disc 304 from valve body 302.

Each open hook receiver 362 is coupled to body 302. In some embodiments, each open hook receiver 362 is coupled to body 302 via a welded joint. Pin 312 is coupled to disc 304 by being disposed within knuckle 320. In some embodiments pin 312 is able to rotate freely while disposed within knuckle 320. Knuckle 320 is attached to disc 304.

To couple disc 304 to body 302, each opposing free end 314 of pin 312 is disposed within the receiving region 370 of a respective open hook receiver 362. Receiving surface 368 of open hook receiver 362 acts to restrain axial movement (i.e downstream movement) of disc 304. Radial movement of disc 304 is restrained by gravity, a ferrule as illustrated in FIG. 2C, or a section of piping attached downstream of sanitary check valve 300. Pin 312 is thus removeably attached to open hook receiver 362 and body 302. Pin 312 is removable from the receiving region 370 of open hook receiver 362 by moving disc 304 in a direction perpendicular to axial fluid flow through flow aperture 305.

Thus disc 304 is permitted to articulate between a closed position where disc 304 is pressed against seating surface 306 and an open position where disc is not pressed against seating surface 306. Since hinge 360 and seating surface 306 only permit disc 304 to open in one direction, sanitary check valve 300 allows only a single direction of fluid flow through the valve.

Thus the configuration of sanitary check valve 300, and specifically of hinge 360, removes the dead space commonly associated with the valve disc hinge as shown above in the prior art. Indeed, hinge 360 is designed such that valve disc 304 is easily removed (separated) from valve body 302, resulting in the complete elimination of dead space. Without dead space, the sanitary check valve 300 is able to be thoroughly cleaned and sanitized. Sanitary check valve 300 can be cleaned when removed from the pumping system, or can be re-installed into a pumping system without its valve disc 304 and flushed along with the full system. By removing dead space, the problems discussed above with respect to cross-contamination of products, bacterial growth, high moisture or humidity, and residual hazardous fluids are eliminated.

Similarly, when an adjacent ferrule is not properly sized or configured against body 302, disc 304 cannot become separated from the remainder of sanitary check valve 300 because disc 304 is retained by hinge 360. Any loosening of the connection between an adjacent ferrule and sanitary check valve 300, misalignment of the ferrule to sanitary check valve 300, missing gasket, loose clamps holding the ferrule to sanitary check valve 300, or similar problem does not risk separation of disc 304.

Sanitary check valve 300 is a further improvement over modified check valve 200 in that valve body 302 is potentially less expensive to manufacture than valve body 202. This is owing to the reduced machining required due to the elimination of recessed portion 230.

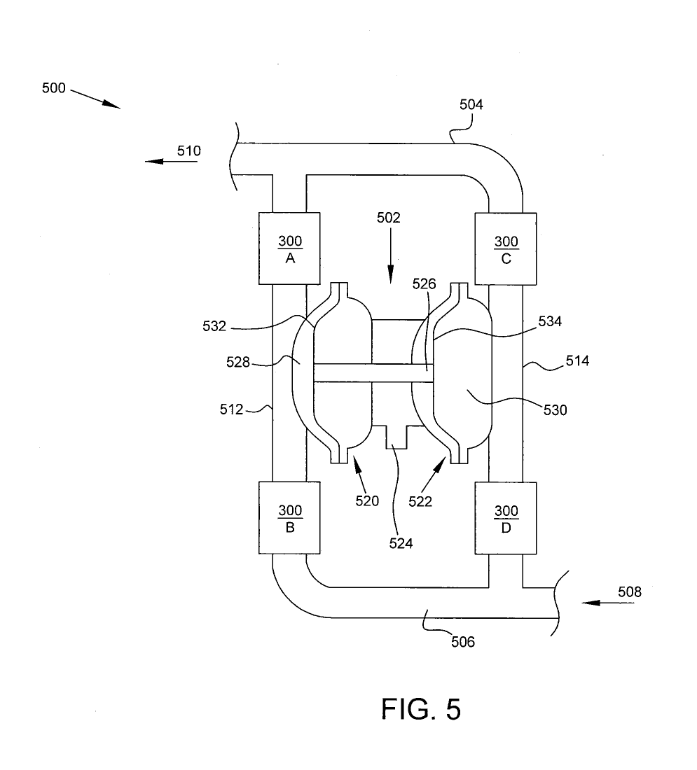

FIG. 5 is a schematic diagram of a diaphragm pump and sanitary check valve assembly 500 in accordance with some embodiments of the present disclosure. The assembly 500 comprises diaphragm pump 502 and sanitary check valves 300-A through 300-D. Diaphragm pump 502 is coupled to a suction manifold 506 and discharge manifold 504. In some embodiments diaphragm pump 502 is a sealed pneumatic pump. In some embodiments, diaphragm pump 502 comprises an air inlet 524, shaft 526 coupled to diaphragms 532, 534, and a first fluid chamber 528 and second fluid chamber 530. First fluid chamber 528 is in fluid communication with first pump header 512. Second fluid chamber 530 is in fluid communication with second pump header 514.

Sanitary check valves 300-B and 300-D are disposed between first and second pump headers 512, 514 and suction manifold 506. Sanitary check valves 300-A and 300-C are disposed between first and second pump headers 512, 514 and discharge manifold 504. Sanitary check valves 300-A through 300-D are of the design described above with reference to FIGS. 3A-3C. Sanitary check valves 300-A through 300-D are installed in assembly 500 such that they only permit fluid flow in a direction from suction manifold 506 towards discharge manifold 504.

Suction manifold 506 receives fluid from source 508. Discharge manifold 504 discharges fluid to a discharge area 510. In some embodiments, source 508 or discharge area 510 can be a holding tank, product container, transport mechanism, or the like.

In operation, compressed air enters the air inlet 524 and shaft 526 to impart motive force that expands and contracts diaphragms 532, 534. The volume of first fluid chamber 528 and second fluid chamber 530 thus expands and contracts as diaphragms 532, 534 move in an alternating fashion. Thus, fluid is moved from suction header 506 through sanitary check valves 300-B and 300-D and into first pump header 512 and second pump header 514 respectively. Fluid is then pumped through sanitary check valves 300-A and 300-C and into discharge header 504.

In some embodiments suction manifold 506 is replaced with two separate sections of suction pipe such that diaphragm pump 502 is able to take suction from two separate sources or from two separate suction pipes which are coupled to the same source. When taking suction off two separate sources, suction piping operably connected to sanitary check valve 300-B and first pump header 512 draws from a first source while suction piping operably connected to sanitary check valve 300-D and second pump header 514 draws from a second source.

Similarly, in some embodiments discharge manifold 504 is replaced with two separate sections of discharge pipe such that diaphragm pump 502 is able to discharge to two separate areas or two separate discharge pipes connected to the same area. When discharging to two separate areas, discharge piping operably connected to sanitary check valve 300-A and first pump header 512 discharges to a first discharge area while discharge piping operably connected to sanitary check valve 300-C and second pump header 514 discharges to a second area.

Thus, in some embodiments diaphragm pump 502 is configured to take suction from two separate sources and discharge to two separate areas. A first product is pumped from a first source through sanitary check valve 300-B, first pump header 512, and sanitary check valve 300-A to a first discharge area. A second product is pumped from a second source through sanitary check valve 300-D, second pump header 514, and sanitary check valve 300-C to a second discharge area.

In some embodiments diaphragm pump 502 is a fully-draining diaphragm pump as described in U.S. patent application Ser. No. 14/450,009 filed Aug. 1, 2014.

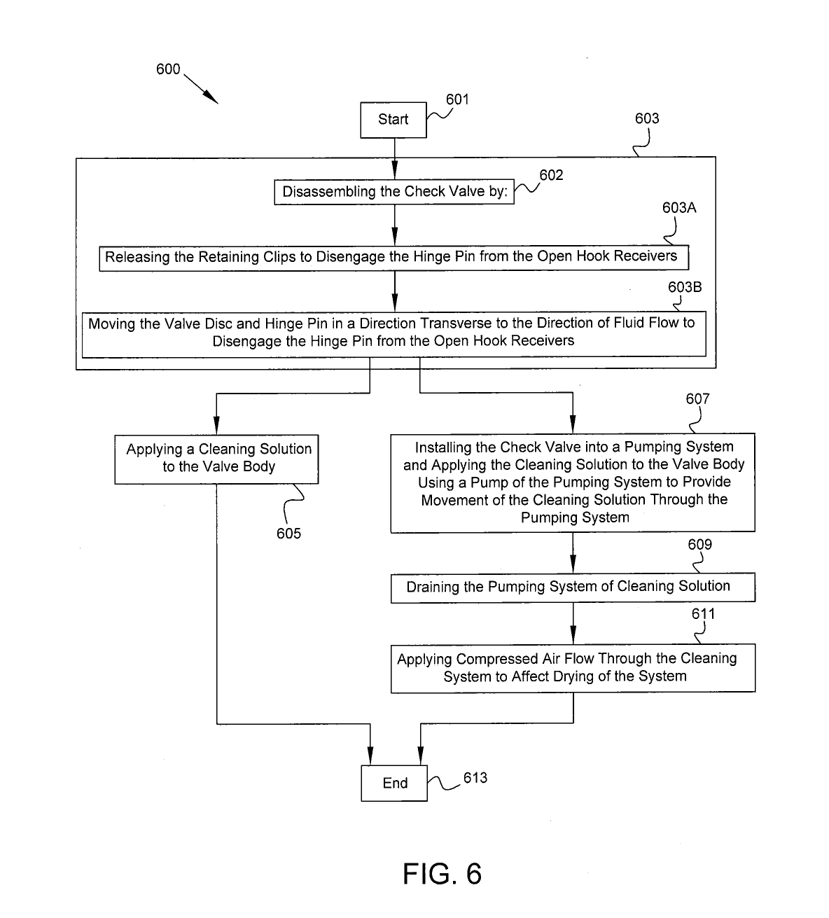

FIG. 6 presents a flow diagram of a method 600 of cleaning a sanitary check valve 300 in accordance with some embodiments of the present disclosure. Method 600 begins at step 601. At step 603, sanitary check valve 300 is optionally disassembled. Step 603 optionally includes step 603A releasing any retaining clip or similar device which is retaining a hinge pin in the open hook receivers of the sanitary check valve 300. Step 603 further includes step 603B, wherein the valve disc 304 and hinge pin 312 are moved in a direction transverse to the direction in which fluid typically flows through the flow aperture 305 of valve body 302. This movement disengages the hinge pin 312 from open hook receivers 362.

The disassembly of sanitary check valve 300 at step 603 is optional because sanitary check valve 300 is also configured to be cleaned in place, which is to say that the sanitary check valve 300 need not be removed from a pumping system in order to clean it. By eliminating dead space, a sanitary cleaning fluid that is pumped through the system is able to clean and sanitize all surfaces of sanitary check valve 300. The cleaning fluid does not remain trapped in the sanitary check valve 300, and sufficient drying of the sanitary check valve 300 is possible once cleaning fluid is drained or evacuated from the system. Thus it is possible to meet all sanitation requirements of the pumping system without removal and disassembly of sanitary check valve 300.

Once the valve disc 304 is separated from the valve body 302, the sanitary check valve 300 can be cleaned either removed from a pumping system or by re-connecting the valve 300 into a pumping system. When cleaned out of the pumping system, as at step 605, a cleaning solution is applied to sanitary check valve 300. Cleaning solutions may comprise water, soaps, ammonia-based cleaning agents, bleach, degreasing agents, and similar fluids commonly used for cleaning. The method 600 then ends at step 613.

When cleaning sanitary check valve 300 as part of a larger system, the disassembled valve (i.e. with valve disc 304 removed) is connected into a pumping system at step 607. Or, as discussed above, the sanitary check valve 300 is connected to a pumping system and remains in its assembled state during cleaning. A pump is used to provide movement to a cleaning solution which is pumped through the pumping system. Once the system is properly flushed via the movement of cleaning solution through the system, the pumping system is drained at step 609. At step 611, pumping system may be optionally dried by applying a compressed air flow through the system, including through valve body 302. The method 600 ends at step 613. After cleaning, sanitary check valve 300 is optionally reassembled and, if require, connected into a pumping system.

The present disclosure thus improves over the prior art by providing a sanitary check valve 300 which is able to be effectively cleaned of fluid consumer products following use, is able to be easily disassembled and inspected, and includes a disc which is firmly retained and not susceptible to separation and entry into the fluid flow. The configuration of sanitary check valve 300, and specifically of hinge 360, removes the dead space commonly associated with the valve disc hinge as shown above in the prior art. Hinge 360 allows valve disc 304 to be easily removed (separated) from valve body 302, resulting in the complete elimination of dead space. Without dead space, the sanitary check valve 300 is able to be thoroughly cleaned and sanitized. The problems discussed above with respect to cross-contamination of products, bacterial growth, high moisture or humidity, and residual hazardous fluids are eliminated.

It will be appreciated by one of skill in the art that although the sanitary check valve is here disclosed in use with a diaphragm pump, the sanitary check valve is also suitable for use in various other systems and configurations, including but not limited to in combination with a centrifugal pump. It will further be appreciated that the sanitary diaphragm pump and the diaphragm pump and sanitary check valve assembly disclosed herein are suitable for a wide range of pumping uses which are not limited to consumer products in a fluid state. Indeed, the present disclosure is suitable for application to pumping of nearly any fluid medium.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A sanitary check valve comprising:
a valve body having a flow aperture and a seating surface disposed circumferentially about the flow aperture;
a valve disc adapted to seat against the seating surface to prevent fluid flow in a first direction and to separate from the seating surface to permit fluid flow in a second direction;
at least one open hook receiver coupled to the valve body; and
a hinge pin coupled to the valve disc, the hinge pin removeably attached to the at least one open hook receiver;
wherein the hinge pin rotates in the at least one open hook receiver to separate the valve disc from the seating surface.

2. The sanitary check valve of claim 1 wherein the open hook receiver is further adapted to allow removal of the hinge pin from the open hook receiver when the hinge pin is moved in a direction perpendicular to the second direction of fluid flow.

3. The sanitary check valve of claim 2 wherein the open hook receiver comprises a radial member and an axial member, and wherein the radial member has a substantially uniform axial width.

4. The sanitary check valve of claim 2 wherein the open hook receiver comprises a radial member and an axial member, and wherein the radial member has an axial width that increases as the radial member extends away from the axial member.

5. The sanitary check valve of claim 3 further comprising a retaining clip disposed between the valve body and the open hook receiver and adapted to retain at least a portion of the hinge pin.

6. The sanitary check valve of claim 5 wherein the hinge pin is coupled to the valve disc via a knuckle.

7. The sanitary check valve of claim 6 further comprising a groove proximate the circumference of the valve body, the groove adapted to receive a gasket.

8. A method of cleaning a check valve having:
a valve body having a flow aperture and a pair of open hook receivers;
a valve disc biased to be disposed across the flow aperture when fluid is flowing in a first direction or when there is no fluid flowing, and to lift away from the flow aperture when fluid is flowing in a second direction;
wherein the valve disc is coupled to the valve body via a hinge pin, the free ends of which are received by the pair of open hook receivers;
the method comprising:
disassembling the check valve by moving the valve disc and hinge pin in a direction transverse to the direction of fluid flow to disengage the hinge pin from the open hook receivers; and
applying a cleaning solution to the valve body.

9. The method of claim 8 further comprising:
installing, after the step of disassembling the check valve, the check valve into a pumping system and applying the cleaning solution to the valve body using a pump of the pumping system to provide movement of the cleaning solution through the pumping system.

10. The method of claim 9 further comprising:
draining the pumping system of cleaning solution; and
applying compressed air flow through the cleaning system to affect drying of the system.

11. The method of claim 8 wherein the check valve additionally has a retaining clip disposed across the open end of each open hook receiver, the method further comprising:
releasing the retaining clips prior to moving the valve disc and hinge pin in a direction transverse to the direction of fluid flow to disengage the hinge pin from the open hook receivers

12. A system for providing motive force to a viscous fluid comprising:
a diaphragm pump adapted to take suction from a suction manifold and discharge to a discharge manifold;
a first sanitary check valve coupled between said diaphragm pump and said suction manifold;
a second sanitary check valve coupled between said diaphragm pump and said discharge manifold;
wherein said first and second sanitary check valves are adapted to permit fluid flow only in a direction from the suction manifold toward the discharge manifold; and
wherein said first and second sanitary check valves each comprise:
a valve body having a seating surface;
a valve disc; and
a hinge for coupling said valve disc with said valve body wherein said hinge comprises a pair of open hook receivers coupled to said valve body and adapted to receive a respective free end of a pin coupled to said valve disc.

13. The system of claim 12 further comprising:
a third sanitary check valve coupled between said diaphragm pump and said suction manifold; and
a fourth sanitary check valve coupled between said diaphragm pump and said discharge manifold.

14. The system of claim 12 wherein each sanitary check valve is coupled to a ferrule on the downstream side of said sanitary check valve.

15. The system of claim 14 wherein said diaphragm pump comprises a fully-draining diaphragm pump.

16. The system of claim 12 wherein said diaphragm pump comprises a first fluid chamber and a second fluid chamber, and wherein each of said first fluid chamber and second fluid chamber take suction from suction manifold and discharge to discharge manifold.

17. The system of claim 16 wherein said suction manifold is in fluid communication with more than one fluid sources.

18. The system of claim 16 wherein said discharge manifold is in fluid communication with more than one fluid discharge areas.
